(19) United States
(12) Patent Application Publication
(10) Pub. No.: US 2003/0192267 A1
(43) Pub. Date: Oct. 16, 2003

(54) Rotating window

(76) Inventor: Jung-Ryul Kim, Seoul (KR)

Correspondence Address: Charles F. Wieland III, Esq., BURNS, DOANE, SWECKER & MATHIS, L.L.P., P.O. Box 1404, Alexandria, VA, 22313-1404, US

(21) Appl. No.: 10/120,495

(22) Filed: Apr. 12, 2002

(51) Int. Cl. E06B 3/00

(52) U.S. Cl. 52/204.5; 52/204.51; 52/656.5; 49/381

(57) ABSTRACT

A window assembly includes a fixed frame and a rotary frame mounted therein. The rotary frame can be unlocked from the fixed frame and rotated relative to the fixed frame about a vertical axis disposed at the center of the rotary frame. The rotary frame can be latched in selected angular positions, or slid horizontally to either the right or the left. The rotary frame can be unlocked from the fixed frame by movement of a single handle.

### BACKGROUND OF THE INVENTION

1. Field of the Invention

The invention relates generally to a rotating window, wherein an inner glass-carrying frame can be rotated about a vertical axis relative to an outer frame.

2. Description of the Prior Art

In general, there has been a rotating window in which a window frame is supported on a window chassis. However, there has not yet been a rotating window that rotates by a 360-degree angle in all directions. In other words, the conventional rotating window does not rotate more than 180 degrees. Therefore, there are problems that the conventional window does not provide stable and space advantages. Further, as there are a lot of gaps between the window frame and the window, water or outside air is introduced into the window frame. In addition, as the conventional rotating window requires a rotation radius, it is inconvenient to use, and a stable view could not be secured.

### SUMMARY OF THE INVENTION

The present invention is provided to solve the aforementioned problems and an object of the present invention is to provide a rotating window that can be rotated by 360 degrees and/or slid to the left or right.

The present invention relates to a window frame assembly which comprises a fixed frame and a rotary frame that is mounted in the fixed frame. The rotary frame carries a transparent sheet, such as glass. The rotary frame is rotatable relative to the fixed frame within a range of substantially 360 degrees about a vertical axis of rotation located at a horizontal center of the rotary frame. A manually releasable locking mechanism is provided for locking the rotary frame against rotation.

Preferably, a latching mechanism is provided for securing the rotary frame in a selected position of angular adjustment.

Preferably, the rotary frame is slidable horizontally within the fixed frame when rotated out of a closed state.

### BRIEF DESCRIPTION OF THE DRAWINGS

The aforementioned aspects and other features of the present invention will be explained in the following description, taken in conjunction with the accompanying drawings, wherein:

FIG. 1 is a front top perspective view of a rotating window assembly according to the present invention;

FIG. 2 shows how the rotating window shown in FIG. 1 can be horizontally slid;

FIG. 3 is a front view, partially broken away, of the window assembly of FIG. 1, showing a first embodiment of a locking mechanism according to the invention;

FIG. 4a is a schematic view of a second embodiment of a locking mechanism;

FIG. 4b is a schematic fragmentary view of part of FIG. 4a;

FIG. 5a is a schematic view showing how a rotary frame of the present invention can be rotated about a vertical axis;

FIG. 5b is a schematic view showing how the rotary frame can be slid horizontally to the right or to the left;

FIG. 6 is a schematic vertical sectional view through the window assembly according to the present invention; and

FIG. 7 is a perspective view of a wheel portion of a latching mechanism according to the invention.

### DETAILED DESCRIPTION OF PREFERRED EMBODIMENTS

The present invention will be described in detail by way of preferred embodiments with reference to the accompanying drawings, in which like reference numerals are used to identify the same or similar parts.

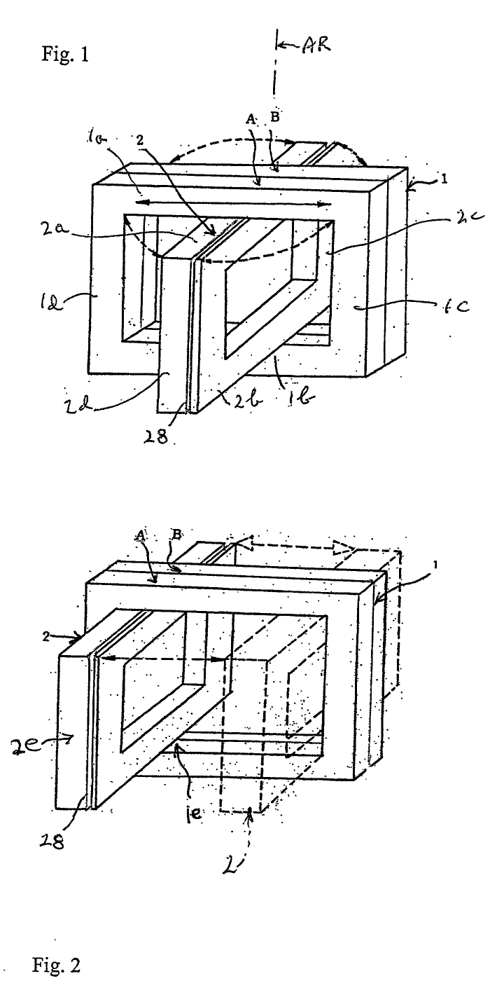

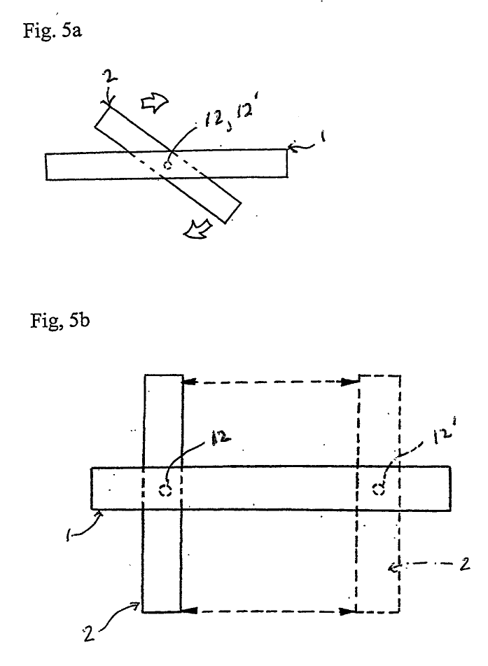

As shown in FIGS. 1 and 2, a window frame assembly includes a rectangular fixed frame 1 and a rectangular rotary frame 2 mounted within the fixed frame. The fixed frame includes an interior half A and an exterior half B. As will be explained, the rotary frame 2 can be unlocked from the fixed frame and rotated relative thereto about a vertical axis of rotation AR within a 360 degree range, as shown by the arrows in FIGS. 1 and 5a. Also, once the rotary frame has been rotated to an open state about the axis A, the rotary frame can be shifted horizontally to the right or to the left, as shown by the arrows in FIGS. 2 and 5b.

The rotary frame 2 carries a transparent sheet 3 such as glass or plastic for example.

The fixed frame 2 includes upper and lower fixed horizontal sections 1a, 1b, and right and left fixed vertical sections 1c, 1d each interconnecting the fixed horizontal sections 1a, 1b. The rotary frame 2 includes upper and lower rotary horizontal sections 2a, 2b, and right and left rotary vertical sections 2c, 2d each interconnecting the rotary vertical sections 2a, 2b.

With reference to FIG. 2, the fixed horizontal and vertical sections 1a-1d together form a fixed peripheral edge surface le which faces a rotary peripheral edge surface 2e defined by the rotary horizontal and vertical sections 2a-2d.

The fixed and rotary frames 1, 2 are connected together by a bearing arrangement comprising upper and lower bearings 4, 6. The upper bearing 4 includes a cylindrical spool 8 mounted in a horizontal slot 10 formed in the upper fixed horizontal section 1a of the fixed frame, and a pin 12 which extends vertically through the fixed and rotary peripheral edge surfaces le, 2e. The spool 8 is fixed to the pin 12 and is rotatable about a vertical axis defined by the pin 12. The spool 8 is also slidable horizontally along the slot 10. The pin 12 is fixed to the upper rotary horizontal section 2a of the rotary frame 2.

The lower bearing 6 is identical to the upper bearing 4 in that it includes a spool 8′, and a pin 12′, the spool being rotatable about the axis of the pin 12′ and slidable along a slot 10′ formed in the lower fixed horizontal section 1b of the fixed frame 1. The pin 12′ is fixed to the lower rotary horizontal section 1b. Both of the pins 12,12′ are vertically aligned and together form the axis of rotation AR of the rotary frame 2.

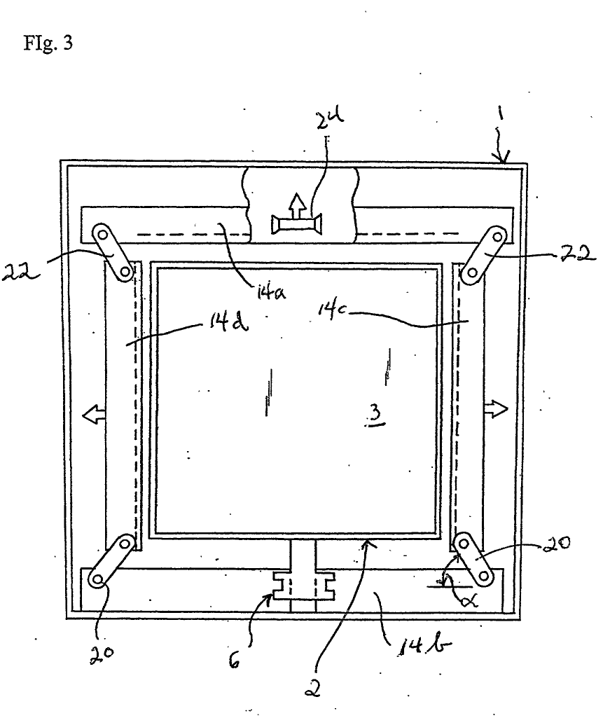

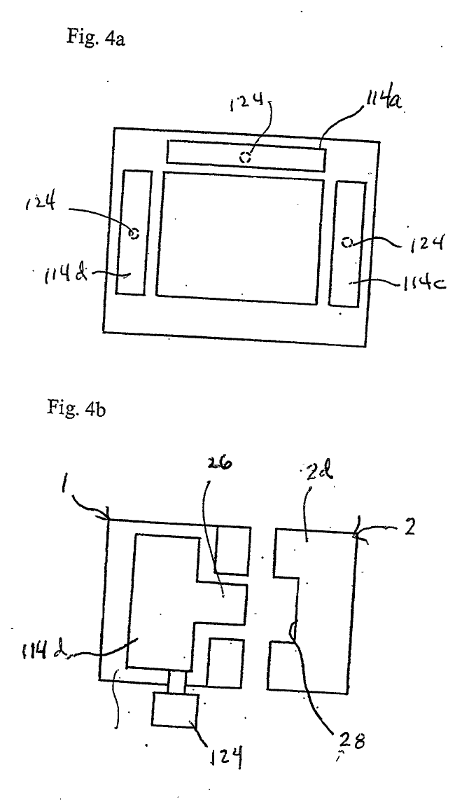

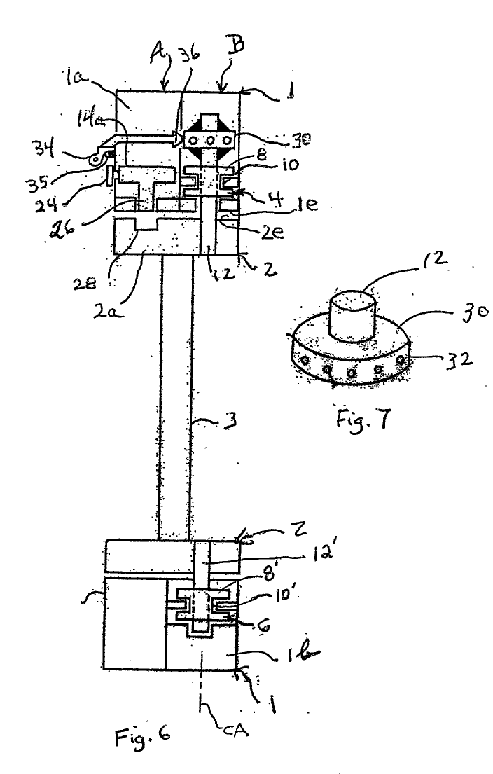

The rotary frame 2 can be locked in a closed state relative to the fixed frame 1 by a locking mechanism that forms a tongue-and-groove arrangement. The locking mechanism includes bar elements 14a-14b mounted in respective sections 1a-1d of the fixed frame I (see FIG. 3). The bar element 14b is fixed within its respective section 1b, whereas the other bar elements 14a, 14c, 14d are movable within their respective sections 1a, 1c, 1d toward and away from the rotary frame 2. The movable bar elements 14c and 14d are connected to the non-movable bar element 14b by pivot links 20, and to the remaining movable bar element 14a by pivot links 22. The links are inclined from the bar elements 14a-14d toward the glass at an acute angle a, e.g. about 75 degrees. Each of the movable bar elements 14a, 14c, 14d includes a tongue 26 (see FIGS. 4b and 6) that is removably received in a groove 28 formed in the rotary peripheral surface 2e of the rotary frame 2. The groove 28 can comprise a continuous groove, or individual groove sections disposed in respective sections 2a, 2c, 2d of the rotary frame. A manual handle 24 is fixed to the movable bar element 14a to enable that bar element to be raised and lowered. Due to the interconnection of the bar elements 14a-14d by the pivot links 22, 24, upward movement of the bar element 14a produces movement of the two bar elements 14c, 14d away from the rotary frame 2 to remove the tongues 26 from the groove 28. That enables the rotary frame to rotate about the axis AR within a 360 degree range as shown in FIGS. 1 and 5a. Moreover, once the rotary frame 2 has been rotated out of a closed state, it is able to be moved horizontally to either the right or left, as shown in FIGS. 2 and 5b.

Once the tongues 26 have been removed from the groove 28, the rotary frame 2 can be rotated without being moved horizontally. The rotary frame can be held in respective angular positions about the axis AR by a latching mechanism which includes a wheel 30 fixed to the pin 12 of the upper bearing 4 so as to be rotatable with the rotary frame 2. That wheel 30 includes a series of recesses in the form of holes 32 spaced circumferentially apart, as shown in FIG. 7. The latching mechanism further includes a latch arm 34 mounted in the upper fixed horizontal section 1a such that a free end of the arm is movable toward and away from the wheel 30. For example, the arm 34 could be mounted for horizontal sliding movement toward and away form the wheel, or the arm 34 could be pivotable about a horizontal axle 35 extending parallel to the glass 3 so that when rotated, the free end thereof will move toward or away from the wheel.

The free end 36 of the arm 34 is able to enter respective ones of the holes 32 to latch the rotary frame in selected angular positions of rotation about the axis AR.

It will also be appreciated that it will be necessary to remove the free end 36 of the latch arm out of the respective hole 32 in order to enable the rotary frame 2 to be moved to the right or the left from a centered position.

To open a closed window, the handle 24 is raised, whereupon the movable bar elements 14a, 14c, 14d are displaced away from the rotary frame 2, whereupon the tongues 26 exit the groove 28 of the rotary frame. This enables the rotary frame 2 to be rotated about the axis AR located at the horizontal center of the rotary frame 2 (see FIGS. 1 and 5a). To rotate the rotary frame 2, it is necessary to displace the latch arm 34 such that the free end 36 thereof exits the respective hole 32 of the wheel 30. The latch arm 34 can be reinserted into a respective hole 32 to secure the rotary frame 2 in a desired angular position. After the rotary frame 2 has been rotated out of the closed state, it can also be slid either to the right or the left (see FIGS. 2 and 5b).

To return the window to a closed state, the rotary frame 2 is returned to a centered position, i.e., with the axis AR centered between the fixed vertical sections of the fixed frame 1, and then rotated about the axis AR until the rotary peripheral edge surface 2e faces the fixed peripheral edge surface le in the manner shown in FIG. 6. Then the latch arm 34 is re-engaged with a respective hole 32 in the wheel 30, and the handle 24 is moved downwardly to reinsert the tongues 26 of the elements 14a, 14c, 14d into the groove 28.

An alternative embodiment of the invention is shown in FIGS. 4a, 4b wherein the movable elements 114a, 114c, 114d of the locking mechanism are not interconnected for simultaneous movement. Rather, those movable elements are separately movable by their own respective handles 124.

The present invention enables a rotary window to be rotated 360 degrees about a short radius and to be moved horizontally in either direction. Thereby rendering the window more versatile and stable as compared to conventional rotary windows. Also, the window requires less space to be opened or closed. A convenient one-touch unlocking mechanism is provided wherein a single handle is moved in order to unlock the rotary frame for rotation.

The present invention has been described with reference to a particular embodiment in connection with a particular application. Those having ordinary skill in the art and access to the teachings of the present invention will recognize additional modifications and applications within the scope thereof.

It is therefore intended by the appended claims to cover any and all such applications, modifications, and embodiments within the scope of the present invention.

What is claimed is:

1. A window frame assembly comprising a fixed frame and a rotary frame mounted in the fixed frame; the rotary frame carrying a transparent sheet; the rotary frame being rotatable relative to the fixed frame within a range of substantially 360 degrees about a vertical axis of rotation located at a horizontal center of the rotary frame; and a manually releasable locking mechanism locking the rotary frame against rotation.

2. The window frame assembly according to claim 1 wherein the locking mechanism includes a tongue-and-groove arrangement.

3. The window frame assembly according to claim 2 wherein a groove portion of the tongue-and-groove assembly is formed in the rotary frame.

4. The window frame assembly according to claim 1 wherein the fixed frame and the rotary frame are rectangular and each includes two horizontal sections interconnected by two vertical sections; the fixed frame including a fixed peripheral edge surface facing a rotary peripheral edge surface of the rotary frame; the locking mechanism including movable bar elements mounted to the fixed frame for movement toward and away form the rotary frame; each bar element including a tongue receivable in a groove formed in the rotary peripheral edge surface; the tongues being removable from the groove in response to movement of the bar elements away from the rotary element.

5. The window frame assembly according to claim 4 wherein the movable bar elements are interconnected to enable all of the movable bar elements to move together.

6. The window frame assembly according to claim 5 wherein the movable bar elements are interconnected by pivot links.

7. The window frame assembly according to claim 6 wherein two of the movable bar elements are connected to a portion of the fixed frame by pivot links.

8. The window frame according to claim 1 further including a manual latching mechanism for securing the rotary frame in selected angular positions of rotation.

9. The window frame according to claim 1 including upper and lower bearings mounted in the fixed frame and including respective upper and lower vertical rotatable pins; the upper and lower rotatable pins fixedly secured to upper and lower horizontal sections, respectively, of the rotary frame at a center of the rotary frame; the upper and lower pins being aligned to form a vertical axis of rotation.

10. The window frame according to claim 9 further including a wheel connected to one of the upper and lower pins and having circumferentially spaced recesses formed therein; a latching mechanism including a latching arm mounted in the fixed frame and arranged to selectively engage the recesses to secure the rotary frame in respective angular positions of rotation.

11. The window assembly according to claim 9 wherein the bearings are horizontally slidable along respective slots formed in the fixed frame.

12. The window assembly according to claim 1 wherein the rotary frame is slidable horizontally within the fixed frame when rotated out of a closed state.

13. A window frame assembly comprising a rectangular fixed frame and a rectangular rotary frame mounted within the fixed frame; the rotary frame carrying a transparent sheet; the fixed frame including upper and lower fixed horizontal sections, and right and left fixed vertical sections each interconnecting the fixed horizontal sections; the rotary frame including upper and lower rotary horizontal sections and first and second rotary vertical sections each interconnecting the rotary horizontal sections; the fixed horizontal sections and the fixed vertical sections together forming an outer peripheral edge surface; the rotary horizontal sections and the rotary vertical sections together forming an inner peripheral edge surface facing the outer peripheral edge surface; the upper fixed horizontal section being connected to the upper rotary horizontal section by an upper bearing; the lower fixed horizontal section being connected to the lower rotary horizontal section by a lower bearing disposed beneath and in alignment with the upper bearing, wherein the upper and lower bearings together define a vertical axis of rotation for the rotary frame; the axis of rotation disposed at a horizontal center of the rotary frame, wherein the rotary frame is rotatable out of a closed state relative to the fixed frame to an open state within a substantially 360° range of rotation; and a locking mechanism releasably locking the fixed frame to the stationary frame to prevent rotation of the rotary frame; the locking mechanism being manually releasable.

14. The window frame assembly according to claim 13 wherein the locking mechanism comprising a tongue-and-groove structure; the tongue being manually removable from the groove.

15. The window frame assembly according to claim 14 wherein a groove portion of the tongue-and-groove structure is formed in the inner peripheral edge surface; the tongue portion of the tongue-and-groove structure being mounted on the fixed frame and including a handle enabling the tongue portion to be moved into and out of locking engagement with the groove portion.

16. The window frame assembly according to claim 13 further including a latching mechanism for releasably securing the rotary frame in selected angular positions around the axis of rotation.

17. The window frame assembly according to claim 16 wherein the latching mechanism comprises a wheel disposed within the fixed frame and affixed to one of the bearings for rotation with the rotary frame, and a latch carried by the fixed frame and manually movable into selected ones of a plurality of recesses formed in the wheel, the recesses spaced apart about the axis of rotation.

18. The window frame assembly according to claim 16 wherein the upper and lower bearings are movable horizontally along the guide slots formed in respective ones of the upper and lower fixed horizontal sections, when the rotary frame has been rotated out of its closed state.

19. The window frame assembly according to claim 18 wherein the bearings are movable horizontally selectively toward either of the fixed vertical sections of the fixed frame.
